(19) United States
(12) Patent Application Publication
(10) Pub. No.: US 2009/0078639 A1
(43) Pub. Date: Mar. 26, 2009

(54) Biofilter media and biofiltration apparatus employing same

(76) Inventor: Calvin Pride, Rockland (CA)

Correspondence Address: ADAMS PATENT & TRADEMARK AGENCY, P.O. BOX 11100, STATION H, OTTAWA, ON, K2H 7T8, CA

(21) Appl. No.: 12/232,550

(22) Filed: Sep. 19, 2008

Related U.S. Application Data
(60) Provisional application No. 60/960,237, filed on Sep. 21, 2007.

(51) Int. Cl. B01D 39/04; B01D 24/00

(52) U.S. Cl. 210/283; 210/500.1; 210/263; 210/290

(57) ABSTRACT

A filter medium comprises a mass of elongate, differently orientated, shape-sustaining elongate elements comprising a sponge material, the different orientation of the elements causing these to form a self-supporting open network which provides substantial interstitial space between the elements, this space preferably being larger than the total volume of the elements themselves. The sponge material may be cellulose or PVA. The elements may be tubular, or they may have a reinforcing core to retain their shape. The reinforcing core may be of stiff synthetic plastic material. Filtration apparatus comprises such a mass of filter medium in a tank with ports for admitting air for filtering and exhausting filtered air. The tank may be separated into several sections by perforated screens supporting respective layers of filter medium.

### CROSS-REFERENCE TO RELATED APPLICATIONS

This application claims priority from U.S. Provisional patent application No. 60/960,237 filed Sep. 21, 2007, the entire contents of which are incorporated therein by reference.

### TECHNICAL FIELD

This invention relates to biological filtration systems and to biofilter media for use therein. The invention is especially applicable to biofilter media suitable for controlling odorous and volatile organic compounds (VOC) emissions in a variety of industrial applications such as wastewater treatment facilities, composting plants, rendering plants and food processing operations.

### BACKGROUND

In known biological filtration systems, fluids that are odorous and/or contain volatile organic compounds are treated in a biofilter bed, which may be composed of organic or inorganic material. More specifically, the fluid stream contacts a biofilm (formed by moisture in the bed) in which the microorganisms live. The compounds to be treated are absorbed into, or adsorbed onto this biofilm where they can be broken down by the microorganisms. It is desirable for the biofilter medium to have a relatively large surface area for contacting the fluid to be filtered, yet occupy a relatively small volume, be able to retain its shape, and be relatively open so as not to impede the passage of the gases through it and so cause increased back-pressure. The large surface area/small volume requirement usually means that the interstices in the filter medium will be relatively small, which means that they will tend to get clogged more easily, increasing backpressure.

Traditional organic biofilter media, such as peat bark and sawdust, decompose easily, reducing or closing interstices in the medium. This not only reduces the effectiveness of the filter medium itself but also causes the back-pressure generated by the bed to increase quite rapidly. High back-pressure leads to high energy costs to run the system, so the biofilter medium needs to be replaced after a relatively short period of time. Compounding this problem is the growth of biomass, which also tends to clog the interstices. Of course, there is a trade-off between the saving in energy cost and the labour and material cost incurred to replace the medium frequently. Some organic media, by their nature, tend to compact easily (e.g. pure compost) which also leads to a relatively high back-pressure, even before decomposition occurs. To overcome this problem, other materials (e.g. styrene spheres, branches) are added to the material to help maintain loft. Another problem associated with compaction and increasing back-pressure, especially of organic media, is the potential creation of fissures or channels which act as “shortcuts” allowing the fluid stream to pass through the filter bed medium without contacting a requisite area of the filter medium or biofilm and the microorganism it carries.

While inorganic biofilter media do not decompose, they may suffer from other disadvantages. For example, rock wool tends to compact easily, especially when wet producing relatively high back-pressure. Other inorganic biofilter media, such as ceramic media or sea shells, have a low water-holding capacity, at least as compared to sponge materials. Most of the inorganic biofilter media which are commercially available at present are granular, and the constituent grains or pellets are usually spherical and readily pack, increasing initial back pressure. These media are easily clogged with pollutants and biomass, and have an inherently high back pressure due to packing. A biofilter disclosed in U.S. Pat. No. 6,617,155 (Van Toever) uses pellets having corrugations or surface ridges to maintain throughflow as the pellets compact. Despite this, and that fact that it uses a fluidized-bed arrangement, the pellets may still tend to compact as a result of the pressure exerted by the filtrate.

WO2006/126797 discloses a biofilter medium comprising beads formed by combining organic (e.g. compost) and inorganic (e.g. rock wool) biofilter media with activated carbon, organic and inorganic binding agents. This too has not solved the problem of back-pressure build-up, as the overall structure of the medium, i.e., the whole biofilter bed, is too compact.

The problems associated with compaction and, where applicable, decomposition have been addressed by stirring or agitating the biofilter medium periodically. For example, U.S. Pat. No. 7,157,271 (Ryu et al.) issued Jan. 2, 2007 discloses a cylindrical tank having several compartments each containing filter medium, specifically polyurethane foam, supported by a carrier and nozzles for spraying nutrients and water onto the medium. The cylindrical axis of the tank is vertical and a drive motor connected to carriers rotates them periodically to stir or agitate the medium in each compartment. U.S. Pat. No. 5,413,936 (Rupert) also discloses a cylindrical tank containing the filter medium (horse manure and mulch) but, in this case, the cylindrical axis of the tank is horizontal and the entire tank is rotated to agitate the medium.

U.S. Pat. No. 6,403,366 (Kim) discusses at length earlier biofiltration devices and the way in which they addressed the problems of compaction, fissures and decomposition. Kim '366 proposed, therefore, using a “microbial foam” filter medium and rotating it periodically so that excessive biomass sloughs off in the submerged phase. In his subsequent U.S. Pat. No. 7,189,281, Kim acknowledges that the rotating tank device disclosed in U.S. Pat. No. 6,403,366 was generally unreliable because its mechanical drive needed frequency repair and replacement. Also, the microorganisms were exposed to much more water than required as a result of submerging the filter medium half of the time and the airflow biased the medium to move towards the centre of the rotating tank.

In U.S. Pat. No. 7,189,281, Kim disclosed an attempt to overcome the limitations of his earlier biofilter by means of paddles, like a water wheel, for distributing water, additional components to apply supplemental fluid and, in some cases, additional control systems. This is not entirely satisfactory, however, because it makes the biofilter even more complicated and increases the number of components to be maintained and repaired.

Ryu et al mention clogging caused by growth of the microorganism itself. This is usually an issue with biofilters over time, but especially with ones that have limited pore space due to packing.

For other examples of biofiltration systems and biofilter media, the reader is directed to CA 2542101, KR 20060120971, KR 20060109367, KR 20040091965, KR 20020054304, KR 20010018396, GB 2336361, U.S. Pat. No. 5,747,331 and U.S. Pat. No. 5,691,192.

Thus, known attempts to solve the problems of biofilter media becoming inefficient, and energy and maintenance costs increasing, as a result of closing of interstices as the medium compacts and/or decomposes, with ensuing increased backpressure, generally involve complicated equipment and concomitant expense, either when making the biofilter medium, or to stir or agitate it when in use, or both.

An object of the present invention is to overcome or at least mitigate the limitations of such known biofilter media and systems, or at least provide an alternative.

### SUMMARY OF INVENTION

According to one aspect of the present invention, there is provided a biofilter medium comprising a mass of elongate shape-sustaining, differently orientated elements of cellulose sponge and/or polyvinyl acetate (PVA) sponge. Normally, the elements will be randomly orientated. The different orientation of the elements causes these to form a self-supporting open network which provides substantial interstitial space between the elements. The interstitial space may be larger, and preferably much larger, than the total volume of the elements themselves.

Each elongate element of cellulose sponge and/or PVA sponge may be configured, for example shaped and sized, so as to make it shape-sustaining. For example, it might be tubular, whether of cylindrical or rectangular cross-section; this would not only resist bending but also would increase the surface area of the sponge contacted by the fluid stream being filtered. A honeycomb or geodesic structure formed from said elongate elements is also envisaged to provide structural strength and a relatively large filter area.

Additionally or alternatively, each element of sponge may be provided with a reinforcing member to sustain its shape. Thus, each element may be reinforced with a solid relatively stiff reinforcing rod of, for example, a stiff synthetic plastics material such as polyvinylchloride (PVC).

The dimensions of each element of sponge material will generally depend upon the particular material from which it is made and the type of reinforcement, if any. Typically, however, for treating gases emanating from a waste treatment facility the element length might be in the range from about 5 centimeters to more than 30 centimeters, and the thickness might vary correspondingly from less than 0.5 cm to about 3 cm or more. The length to width ratio may be between 2 and 20. The elongate shape facilitates the creation of a filter bed comprising an interlocking network of individual elongate elements that maintains its overall shape and structure, without substantial packing.

While most of the elements will be elongate, the bed may include a relatively small number of elements that are not elongate.

According to a second aspect of the present invention, there is provided biofiltration apparatus comprising a filter bed formed by a loosely-packed mass of the differently orientated elongate elements which form a self-supporting open network which provides a large interstitial space.

The apparatus may further comprise a humidification system for maintaining bed moisture which helps to keep the biomass active; and/or means for maintaining the temperature in the filter bed in a suitable operating range, typically from 12 to 40 degrees Celsius; and/or means for removing chemical accumulation and excess biomass from the filters. The removing means may comprise a backwashing device, such as irrigation hoses buried in the bed or spray nozzles and operated via a timer and solenoid valve.

The cellulose and polyvinyl acetate (PVA) sponge materials are durable, have high water holding capacity which keeps the material biologically active, and are excellent surfaces for hosting bacteria. The elongate shape of each piece of filter material keeps the bed structure durable and keeps the bed back-pressure relatively low.

Various objects, advantages and features of the present invention will be apparent from the following description of an embodiment of the present invention, which is described by way of example only and with reference to the accompanying drawings.

### BRIEF DESCRIPTION OF THE DRAWINGS

In the drawings, identical or corresponding elements in the different Figures have the same reference numeral.

FIG. 1 is a perspective view, partly broken away, of biofiltration apparatus;

FIG. 1A, is an enlarged view of a portion of the interior of the filter bed of FIG. 1, showing the novel filter elements;

FIG. 2 is a perspective view of a filter element;

FIGS. 3A and 3B show respectively a perspective view of a filter element, and of the same element slit down the centre;

FIG. 4 shows a perspective view of an alternative filter element;

FIGS. 5 and 6 show sectional views of biofiltration apparatus in accordance with this invention, respectively at the beginning of the process, and during the process, after compaction; and

FIG. 7 illustrates a modification to the apparatus of FIGS. 1, 5 and 6.

### DESCRIPTION OF PREFERRED EMBODIMENTS

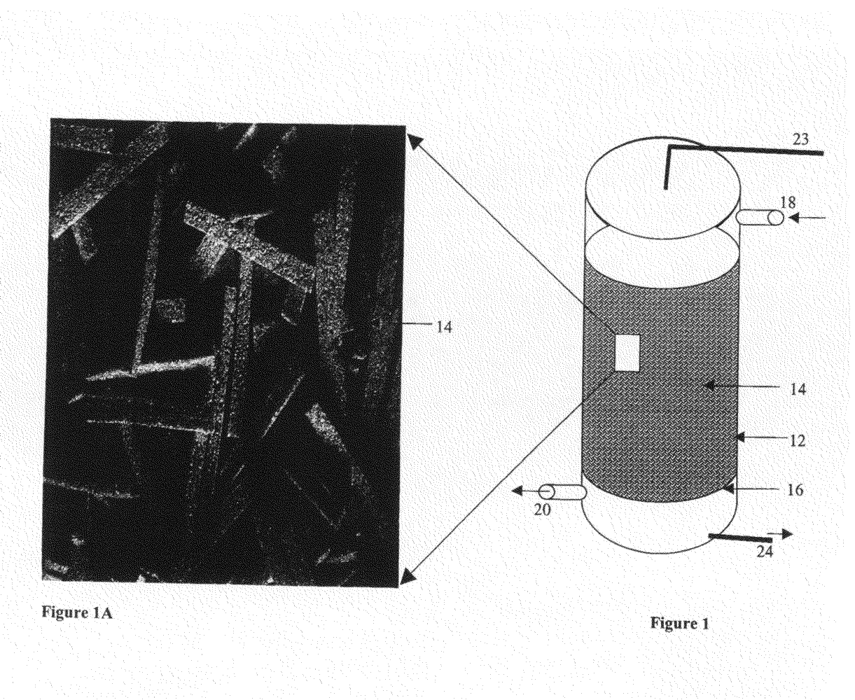

Referring to FIG. 1, biofiltration apparatus for treating fluids, in this specific embodiment air from a wastewater treatment facility, to remove odorous gases, such as ammonia, reduced sulphur compounds (RSCs) (e.g. hydrogen sulphide, methyl mercaptan, dimethyl sulphide) and volatile organic compounds (VOCs), comprises a cylindrical tank 10, shown with its cylindrical axis upright, containing a filter bed 12 in the form of a randomly orientated mass of elongate elements or strips 14 of sponge material 28 forming a filter medium, shown enlarged in FIG. 1a. The bed 12 is supported by a perforated screen 16 near the lower end of the tank 10. The bed 12 has a large volume of interstitial space compared to the total volume of the elements themselves; this void interstitial space may be 75% of the total volume of the bed, at least at the beginning of an operation. The bed 12 has an active area of the sponge material which is similar to conventional beds which are easily compacted with time.

The tank 10 has an air inlet 18 near its upper end, and an air outlet 20 near its lower end, below screen 16. The tank 10 has a humidification spray water inlet 22 at its upper end, and a leachate outlet 24 at its lower end.

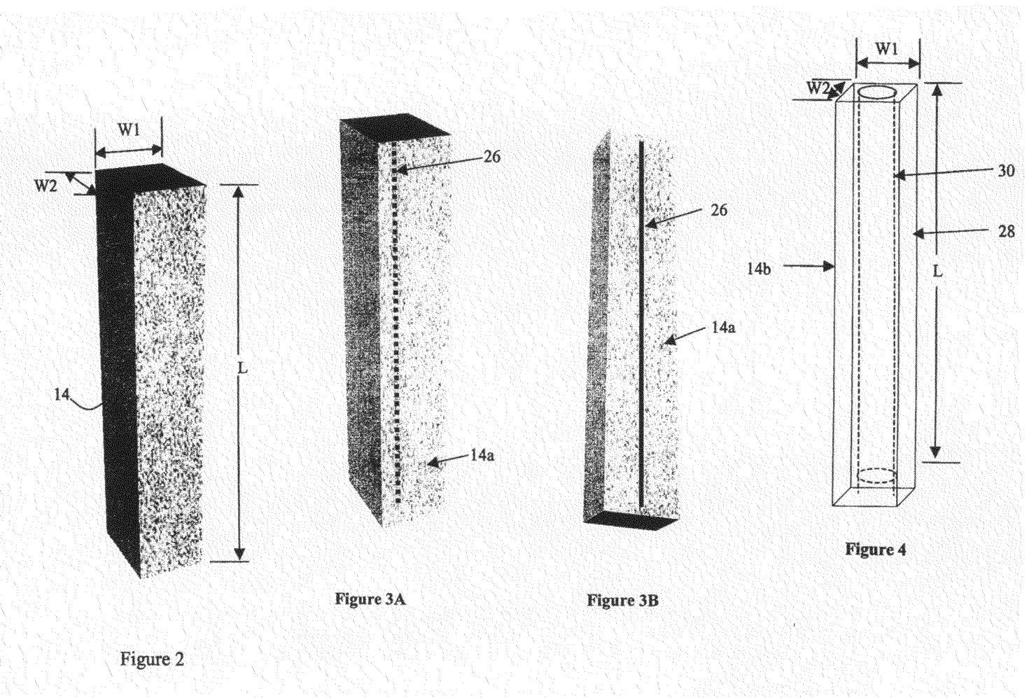

One form of elongate filter element is shown in FIG. 2. This is a straight bar of square cross-section, with a length L of 5 to 30 cm, the length being about 2 to 20 times the width/thickness (W1, W2) dimensions. It is preferably formed as a sponge of cellulose or PVA (poly vinyl acetate. Such an element may be stiff enough to retain its shape when is randomly orientated as shown in FIG. 1A.

Alternatively, in situations where a sponge would not retain its shape under packing pressure in the bed 12, the element 14a may be formed, as shown in FIG. 3A, with a core 26 of solid material, as shown in broken lines. The core 26 may be of PVC, for example, with a layer of the sponge material 28 around the core. FIG. 3B shows the element as cut longitudinally through the center.

FIG. 4 shows a generally similar element 14b, but which may be in the form of a square-sectioned hollow tube of sponge material 28 and having a central cylindrical bore 30. The tubular sponge material 28 may be inherently shape-sustaining, or may be formed about a tube of PCV or PVA, for example, similar in size to the bore 30.

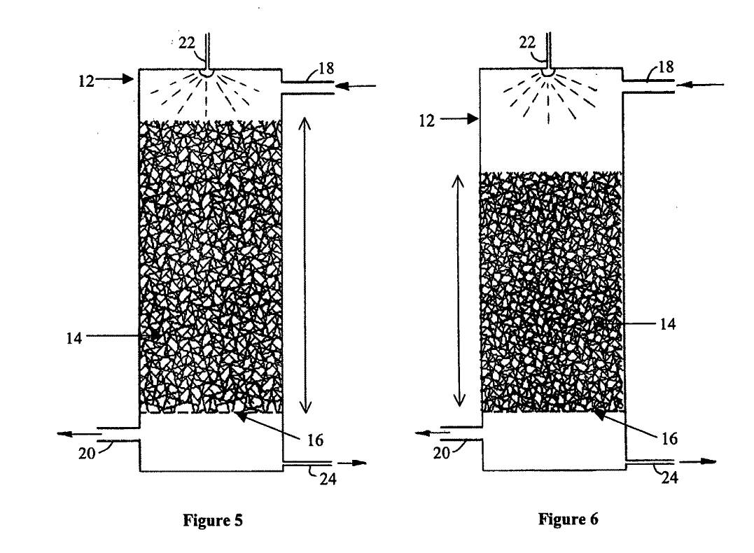

FIGS. 5 and 6 show that, although the bed does pack down during use, the amount of this packing is not very great, or such as would significantly increase the back pressure trough the bed. Thus, FIG. 5 shows the condition at the beginning of the filtration process, and FIG. 6 shows the situation in the middle of the process, in which the depth of the bed has been reduced by perhaps 20%.

For some applications, even such a 20% reduction in the depth of the filter bed may be unacceptable because it results in a reduction of the so-called Empty Bed Retention Time (EBRT). Empty bed retention time (EBRT) is one of the parameters generally used to identify and evaluate the biofilter performance. A consistent EBRT is important in terms of operation and regulation.

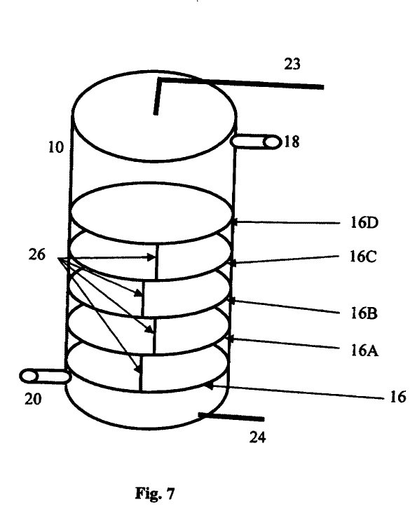

During normal operation, when the biomass is wet, its weight will be significant. Typically, a wet biomass 2 meters deep might exert a pressure of the order of 250 kg/m² at its base and compaction will vary according to the depth of biomass. Empty bed retention time (EBRT), which is the volume of the filter bed divided by the air flow rate, can be further reduced by sub-dividing the biomass into several stacked layers, each supported separately. Thus, FIG. 7 illustrates, as an example, the interior of tank 10 sub-divided by four additional perforated support screens 16A, 16B, 16C and 16D, each similar in construction to screen 16 and supported by three circumferently-spaced legs 26 (only one shown in each case).

In operation, each of the screens 16-16D will support a layer of biomass material that is about one fifth of the overall depth. For example, if the overall interior height of tank 10 is about 2 meters, the spacing between adjacent screens might be about 0.3 meters. The depth of each layer of biomass would be about one fifth of the total depth so the compressive force at the base of each layer would be reduced to about 50 kg/m². It will be appreciated that, although each layer will be subjected to compaction, the density of each lowermost portion will be less than that of the lowermost portion of the single mass of similar overall height, so the flow rate will not be reduced as much.

### INDUSTRIAL APPLICABILITY

Embodiments of the invention advantageously provide a biofilter medium comprising a tangle of elongate shape-sustaining elements which, in comparison with known devices, will maintain the filter bed structure relatively unchanged for a longer period of time while facilitating high microbial activity and relatively much lower back pressure within the filter bed.

Although an embodiment of the invention has been described and illustrated in detail, it is to be clearly understood that the same is by way of illustration and example only and not to be taken by way of limitation, the scope of the present invention being limited only by the appended claims.

The contents of the various patent documents cited hereinbefore are incorporated herein by reference and the reader is directed to them for reference.

1. A filter medium comprising a mass of elongate, differently orientated, shape-sustaining elements comprising a sponge material, the different orientation of the elements causing these to form a self-supporting open network which provides substantial interstitial space between the elements.

2. A filter medium according to claim 1, wherein the interstitial space is larger than the total volume of the elements themselves.

3. A filter medium according to claim 1, wherein the sponge material is cellulose or polyvinyl acetate (PVA).

4. A filter medium according to claim 1, wherein the elements have a length dimension considerably larger than both the width and thickness.

5. A filter medium according to claim 4, wherein said length dimension is between 2 and 20 times a width or thickness dimension.

6. A filter medium according to claim 1, wherein the elements are tubular.

7. A filter medium according to claim 1, wherein the filter elements have a reinforcing core to retain their shape.

8. A filter element according to claim 6, wherein said reinforcing core is of stiff synthetic plastic material.

9. Filtration apparatus comprising a filter bed formed by a loosely packed and mass of elongate shape-sustaining elements each comprising a sponge material, the elements being differently orientated to form an open network which provides substantial interstitial space between the elements.

10. Filtration apparatus according to claim 9, wherein the filter bed comprises a plurality of layers of said loosely packed and differently oriented mass of elongate shape-sustaining elements, each layer being separately supported and disposed so that filtrate passes through each layer in turn.

11. Filtration apparatus according to claim 10, comprising a tank having a plurality of screens spaced apart between an inlet for admission of liquid to be filtered and an outlet for egress of filtrate, each screen supporting a respective one of said layers.

12. Filtration apparatus according to claim 9, wherein the interstitial space is larger than the total volume of the elements themselves.

13. Filtration apparatus according to claim 9, wherein the sponge material is cellulose or PVA.

14. Filtration apparatus according to claim 9, wherein the elements have a length dimension considerably larger than both the width and the thickness.

15. Filtration apparatus according to claim 14, wherein said length dimension is between 2 and 20 times a width or thickness dimension.

16. Filtration apparatus according to claim 9, wherein the elements are tubular.

17. Filtration apparatus according to claim 9, wherein the filter elements have a reinforcing core to retain their shape.

18. Filtration apparatus according to claim 17, wherein said reinforcing core is of stiff synthetic plastic material.
